(19) United States
(12) Patent Application Publication
(10) Pub. No.: US 2020/0406508 A1
(43) Pub. Date: Dec. 31, 2020

(54) THERMOREGULATED MOLD AND METHOD OF FABRICATING THE SAME

(71) Applicant: GM GLOBAL TECHNOLOGY OPERATIONS LLC, Detroit, MI (US)

(72) Inventors: Brennon L. White, Novi, MI (US); Anthony M. Coppola, Rochester Hills, MI (US); Dominick M. Lentine, Macomb, MI (US); Edward T. Kuczynski, Bloomfield Hills, MI (US); Lane G. Lindstrom, Oxford, MI (US)

(73) Assignee: GM GLOBAL TECHNOLOGY OPERATIONS LLC, Detroit, MI (US)

(21) Appl. No.: 16/455,006

(22) Filed: Jun. 27, 2019

(51) Int. Cl. B29C 33/04; B33Y 80/00; B29C 64/165; B29C 33/38

(52) U.S. Cl. CPC B29C 33/04; B33Y 80/00; B33Y 10/00; B29C 33/3842; B29C 64/165

(57) ABSTRACT

A method of fabricating a mold includes 3D printing a first shell using a first material, the first shell having a first interior surface and a first exterior surface, and 3D printing a second shell using a second material different from the first material, the second shell having a second interior surface and a second exterior surface wherein the second interior surface generally conforms to the first exterior surface. The first material may be thermally conductive and the second material may be thermally insulative, and the first and/or second shell may include at least one thermal regulation element formed therein.

### INTRODUCTION

This disclosure relates to methods of fabricating a thermoregulated mold using 3D printing.

Molds may be used for forming parts out of molten metal, molten polymer, expanded foams (e.g., urethane), etc. Molds themselves can be made from a variety of materials, such as metal, composites, compacted sand and the like. For example, a mold may be formed using a binder jet three-dimensional (3D) printing process using sand, carbon powder or metal with binding resin.

Sand molds can be strengthened to some degree by using epoxy, resin or the like either during the mold forming process or as an after-treatment (e.g., sprayed onto the sand mold) after the mold is formed.

### SUMMARY

According to one embodiment, a mold for producing a part includes: a 3D printed outer shell made of a first material, the outer shell having a first interior surface and a first exterior surface; and a 3D printed inner shell made of a second material different from the first material, the inner shell having a second interior surface and a second exterior surface, wherein the inner shell is disposed within the outer shell with the second exterior surface in contact with the first interior surface. The first material may be thermally insulative and the second material may be thermally conductive. The first interior surface may generally conform to the second exterior surface, at least one portion of the inner shell may be electrically conductive, and the inner and outer shells may form a substantially closed container.

A first opening may be formed in a first wall of the inner shell at a first location, and a second opening may be formed in a second wall of the outer shell at a second location corresponding to the first location, wherein the first and second openings cooperate to form an injection port through the first and second walls. The inner and outer shells may form a container having an open top, with the mold further including a 3D printed lid capable of substantially covering the open top. The lid may include a first hinge element and one of the inner and outer shells may include a second hinge element operably connectable with the first hinge element.

The mold may include a 3D printed thermal regulation element formed in at least one of the inner shell and the outer shell. The thermal regulation element may include at least one of: an interior passage having at least one opening formed in a wall of the at least one of the inner shell and the outer shell; a tube formed of a material different from a surrounding material in which the tube is formed; a cartridge heater; a resistance heating wire; and a heat spreader. The thermal regulation element may be 3D printed simultaneously with the at least one of the first mold shell and the second mold shell in which the at least one thermal regulation element is formed.

According to one embodiment, a thermoregulated mold for producing a part includes: a 3D printed first mold shell made of a thermally insulative material, the first mold shell having a first interior surface and a first exterior surface; a 3D printed second mold shell made of a thermally conductive material, the second mold shell having a second interior surface and a second exterior surface, wherein the second exterior surface generally conforms to the first interior surface; and at least one 3D printed thermal regulation element formed in at least one of the first mold shell and the second mold shell. The at least one thermal regulation element may include at least one of: a through-hole passage having an entrance opening and an exit opening, each of the entrance and exit openings being formed in a wall of the at least one of the first mold shell and the second mold shell; a blind hole passage having a single opening formed in a wall of the at least one of the first mold shell and the second mold shell; a tube formed of a material different from a surrounding material in which the tube is formed; a cartridge heater; a resistance heating wire; and a heat spreader. The at least one thermal regulation element may be 3D printed simultaneously with the at least one of the first mold shell and the second mold shell in which the at least one thermal regulation element is formed. The first mold shell, the second mold shell and the at least one thermal regulation element may be 3D printed simultaneously.

A first opening may be formed in a first wall of the first mold shell at a first location and a second opening may be formed in a second wall of the second mold shell at a second location corresponding to the first location, such that an injection port is formed by the first and second openings if the first and second mold shells are nested together with the first and second openings in registration with each other.

The first and second mold shells may form a container having an open top, with the mold further including a 3D printed lid capable of substantially covering the open top, wherein the lid may include a first hinge element and one of the first and second mold shells may include a second hinge element operably connectable with the first hinge element.

According to one embodiment, a method of fabricating a thermoregulated mold for producing a part includes: 3D printing an outer shell using a thermally insulative material, the outer shell having a first interior surface and a first exterior surface; 3D printing an inner shell using a thermally conductive material, the inner shell having a second interior surface and a second exterior surface, wherein the second exterior surface generally conforms to the first interior surface; and 3D printing at least one thermal regulation element in at least one of the outer shell and the inner shell. The at least one thermal regulation element may include at least one of: a through-hole passage having an entrance opening and an exit opening, each of the entrance and exit openings being formed in a wall of the at least one of the outer shell and the inner shell; a blind hole passage having a single opening formed in a wall of the at least one of the outer shell and the inner shell; a tube formed of a material different from a surrounding material in which the tube is formed; a cartridge heater; a resistance heating wire; and a heat spreader.

The outer and inner shells may be 3D printed simultaneously with the inner shell nested within the outer shell with the first interior surface in contact with the second exterior surface. Alternatively, the outer and inner shells may be 3D printed separately, with the method further including fitting the inner shell within the outer shell with the first interior surface in contact with the second exterior surface.

A first opening may be formed in a first wall of the outer shell at a first location and a second opening may be formed in a second wall of the inner shell at a second location corresponding to the first location, such that the first and second openings cooperate to form an injection port if the outer and inner shells are nested together with the first and second openings in registration with each other. The outer and inner shells may be formed such that nested together they form a container having an open top, with the method further including: 3D printing a lid capable of substantially covering the open top, wherein the lid includes a first hinge element and one of the outer and inner shells includes a second hinge element operably connectable with the first hinge element.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIGS. 1A and 1B are exploded and assembled perspective sectional semi-schematic views, respectively, of a thermoregulated mold in accordance with the disclosure.

FIG. 2 is a flowchart for producing a thermoregulated mold in accordance with the disclosure.

FIGS. 3A through 3E are side schematic sectional views of a thermoregulated mold produced by various production and assembly processes in accordance with the disclosure.

FIGS. 4A and 4B are close-up side sectional views of a thermoregulated mold showing an injection port in accordance with the disclosure.

FIGS. 5A and 5B are side sectional schematic and top schematic views, respectively, of a thermoregulated mold in accordance with the disclosure.

FIG. 6 shows a partial sectional side view of an outer shell of a thermoregulated mold in accordance with the disclosure.

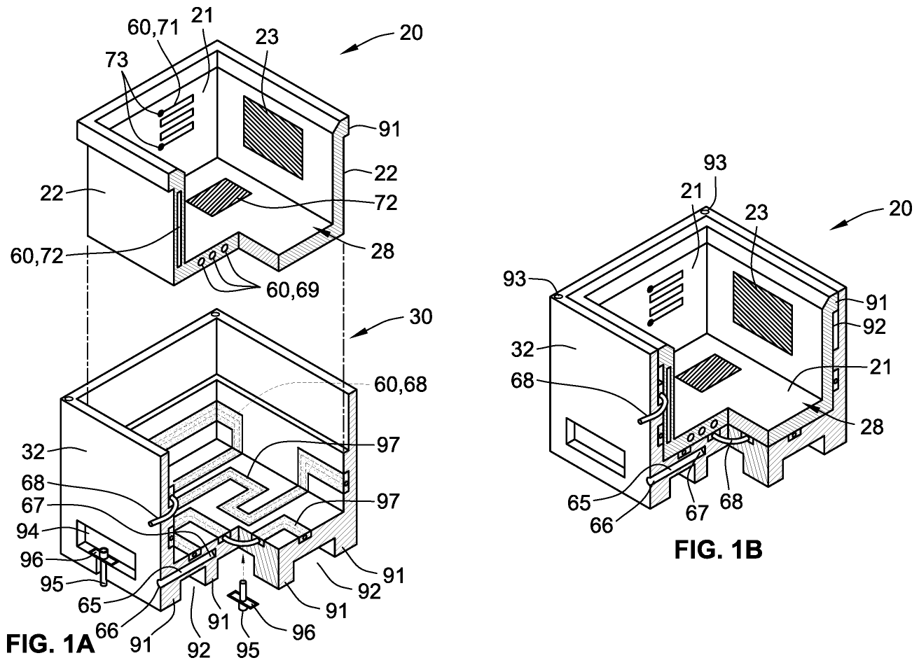

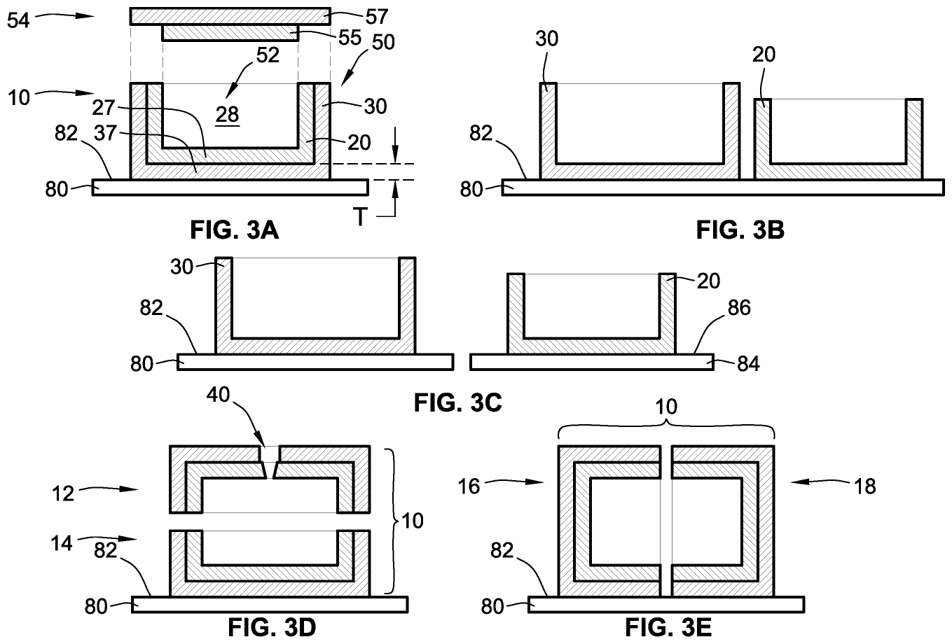

Note that some of the drawings herein are presented in multiple related views, with the related views sharing a common Arabic numeral portion of the figure number and each individual view having its own unique “alphabetic” portion of the figure number. For example, FIGS. 1A and 1B are exploded and assembled views, respectively, of a thermoregulated mold according to an embodiment of the disclosure; both related views share the same Arabic numeral (i.e., 1), but each individual view has its own unique “alphabetic” designation (i.e., A or B). When drawings are numbered in this way, reference may be made herein to the Arabic number alone to refer collectively to all the associated “alphabetics”; thus, “FIG. 3” refers to FIGS. 3A through 3E collectively. Likewise, “FIG. 4” refers to FIGS. 4A and 4B collectively.

### DETAILED DESCRIPTION

Referring now to the drawings, wherein like numerals indicate like parts in the several views, a thermoregulated mold 10 and a method 100 for making the mold 10 by 3D printing or other additive manufacturing processes are shown and described herein.

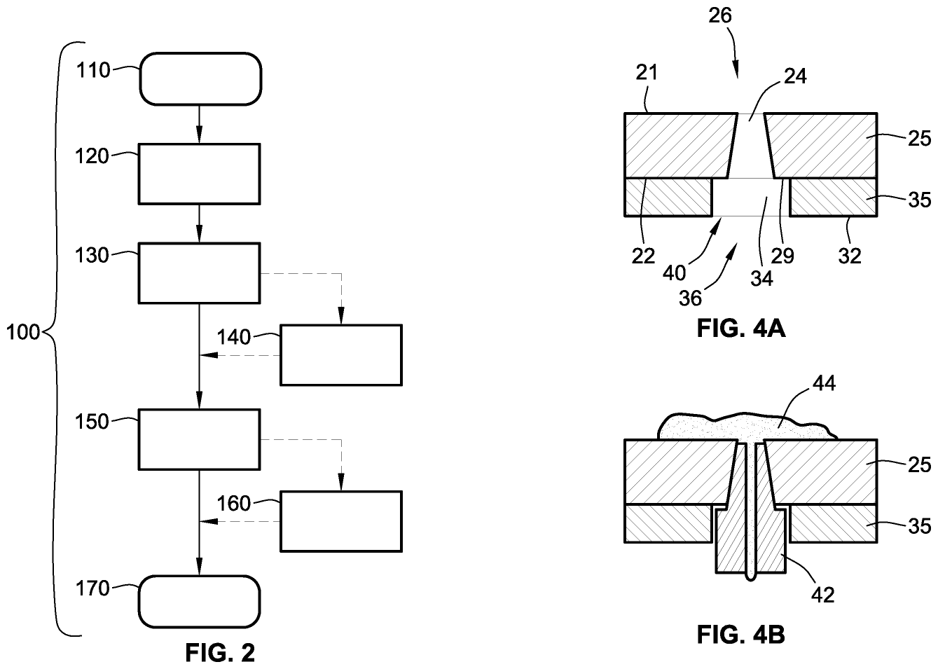

FIG. 1A shows an exploded view of a first or “outer” mold shell 30 and a second or “inner” mold shell 20, which together form a thermoregulated mold 10 when the second/inner shell 20 is nested within the first/outer shell 30 as exemplified in FIG. 1B. Referring also to the flowchart shown in FIG. 2, a method 100 of fabricating the mold 10 (e.g., for producing a part having an outer part surface) according to one embodiment starts at block 110 and ends at block 170, and includes, at block 120, 3D printing the first/outer shell 30 using a first material, the first shell 30 having a first interior surface 31 and a first exterior surface 32. At block 130, the second/inner shell 20 is 3D printed using a second material different from the first material, the second shell 20 having a second interior surface 21 and a second exterior surface 22 wherein the first interior surface 31 generally conforms to the second exterior surface 22. The first material (for the outer shell 30) may be thermally insulative and the second material (for the inner shell 20) may be thermally conductive. For example, the second material may have a higher coefficient of thermal conductivity than the first material; e.g., the second material may contain carbon, copper and/or other thermally conductive materials, while the first material may contain fiberglass, refractory/ceramic fillers and/or other thermally insulative materials (including materials that are less thermally conductive than the materials used in the second material).

FIG. 3 schematically illustrates various production and/or assembly processes for producing a thermoregulated mold 10 according to the present disclosure. As shown in FIG. 3A, the first and second shells 30, 20 may be 3D printed simultaneously and “nested-in-place”, such as on a top surface 82 of a platen or workspace 80, with the second/inner shell 20 nested within the first/outer shell 30. In this configuration, blocks 120 and 130 (i.e., 3D printing the inner shell 20 and outer shell 30, respectively) may be combined as a single simultaneous execution. This type of simultaneous/nested-in-place approach would not require a subsequent step of placing or nesting the inner shell 20 inside the outer shell 30, because the two shells 20, 30 would already be in a nested arrangement as they are being 3D printed.

Note that, as used herein, “simultaneously” means as part of a single ongoing production process or as a single pass. So, 3D printing the inner and outer shells 20, 30 “simultaneously” does not mean that both shells 20, 30 are being printed at the very same point in time, but that both are being printed as part of the same 3D printing instance or production pass or printing session. For example, as can be seen in FIG. 3A, the first/outer shell 30 is disposed atop the surface 82 of the platen or workspace 80, so the portion 37 of the outer shell 30 that lies in contact with the platen surface 82 would be 3D printed first, and when that thickness T has been printed, then the portion 27 of the inner shell 20 that lies atop portion 37 may be printed. Also, at some points during a given 3D printing session the 3D printer may be printing a part of the outer shell 30 or a part of the inner shell 20, and may be continuously switching back and forth between printing parts of one shell or the other, yet this continuous process of printing results in both shells 20, 30 being printed, in a nested configuration (or separately if so desired) at the end of the 3D printing pass. Also, “nested-in-place” means that the shells 20, 30 are produced such that they are formed in an already-nested arrangement as part of the 3D printing process, as illustrated in FIG. 3A. Thus, when both shells 20, 30 are 3D printed simultaneously and nested-in-place, no subsequent step would be needed of inserting or nesting the inner shell 20 into the outer shell 30.

Alternatively, as shown in FIG. 3B, the first and second shells 30, 20 may be 3D printed simultaneously but separately (i.e., not already nested or nested-in-place). In this configuration, blocks 120 and 130 may be executed simultaneously, and the shells 20, 30 may even be produced on the same platen or workspace 80, but they would be produced at two separate locations on the platen or workspace 80. Or, as illustrated in FIG. 3C, the outer shell 30 may be produced on the surface 82 of a first platen or workspace 80 and the inner shell 20 may be produced on the surface 86 of a second platen or workspace 84, either simultaneously (in which case blocks 120 and 130 may be executed simultaneously) or at two separate times (in which case blocks 120 and 130 may be executed at two separate times). In the arrangements illustrated in FIGS. 3B and 3C, once both shells 20, 30 are 3D printed, the second/inner shell 20 may be inserted, fitted, assembled or nested within the first/outer shell 30, which is shown at block 140. Note that while block 140 (i.e., fitting or nesting the inner and outer shells 20, 30 together) is appropriate for the configuration illustrated in FIGS. 3B and 3C, block 140 would not be relevant to the configuration illustrated in FIG. 3A where the two mold shells 20, 30 are produced in a nested arrangement as part of the 3D printing process. (For this reason, the flow lines for block 140 are shown as dashed lines to indicate this is an execution block which is optional; i.e., it depends on whether the first and second shells 30, 20 are printed already-nested or not.)

As shown in FIG. 1A, at least one portion 23 of the inner shell 20 may be electrically conductive. This may be accomplished by using a material that is electrically conductive (e.g., copper particles) when this portion 23 of the inner mold shell 20 is being 3D printed. (Alternatively, one or more metallic inserts may be placed into portion 23, either during the 3D printing process or afterward or both. In either case, the 3D printing process may be programmed so as to leave one or more voids in the region 23 where the metallic inserts may be inserted.) The particular material used for 3D printing this portion 23 of the inner shell 20 may thus be both thermally conductive and electrically conductive. By providing one or more portions 23 of the inner mold shell 20 with electrically conductive material, such portion(s) 23 may be inductively heated by providing magnetic flux to the inner shell portions 23, such as by activating an electric current near such mold portions 23. For example, the outer shell 30 may include one or more wires or coils proximate the inner shell region 23 in order to provide current/magnetic flux proximate or near such region 23.

As illustrated in FIGS. 4A and 4B, a first opening 24 may be formed in a first wall 25 of the inner shell 20 at a first location 26, and a second opening 34 may be formed in a second wall 35 of the outer shell 30 at a second location 36 corresponding to the first location 26. The inner and outer shells 20, 30 may be produced with these openings 24, 34 being formed at the corresponding locations 26, 36 such that in a nested configuration (such as illustrated in FIGS. 1B and 3A), the first and second openings 24, 34 are aligned with each other and cooperate to form an injection port 40 through the first and second walls 25, 35. This port 40 may be sized and shaped to accommodate an injector nozzle 42, through which a material 44 (e.g., expandable urethane foam) may be injected. For example, the opening 34 in the outer shell wall 35 may be a circular (cylindrical) hole having a diameter corresponding to the outer diameter of the injector 42, and the opening 24 in the inner shell wall 25 may be a tapered through-hole having a major diameter at the first exterior surface 22 of the inner shell 20 and a minor diameter at the first interior surface 21 of the inner shell 20, with the major diameter of the tapered hold 24 being smaller than the diameter of the circular (cylindrical) hole 34. With this relative sizing of the diameters, and with the two openings 24, 34 located in the inner/outer walls 25, 35 such that the centers of the two openings 24, 34 are aligned when the shells 20, 30 are nested together, the resulting injection port 40 will have an annular shoulder 29 formed by the exterior surface 22 of the inner shell wall 25 against which the injector nozzle 42 may be seated upon insertion into the port 40. The diameters and geometry of the port 40 may be selected such that the injector nozzle 42 may be sealably engaged with the port 40 with little or no leakage of the injected material 44.

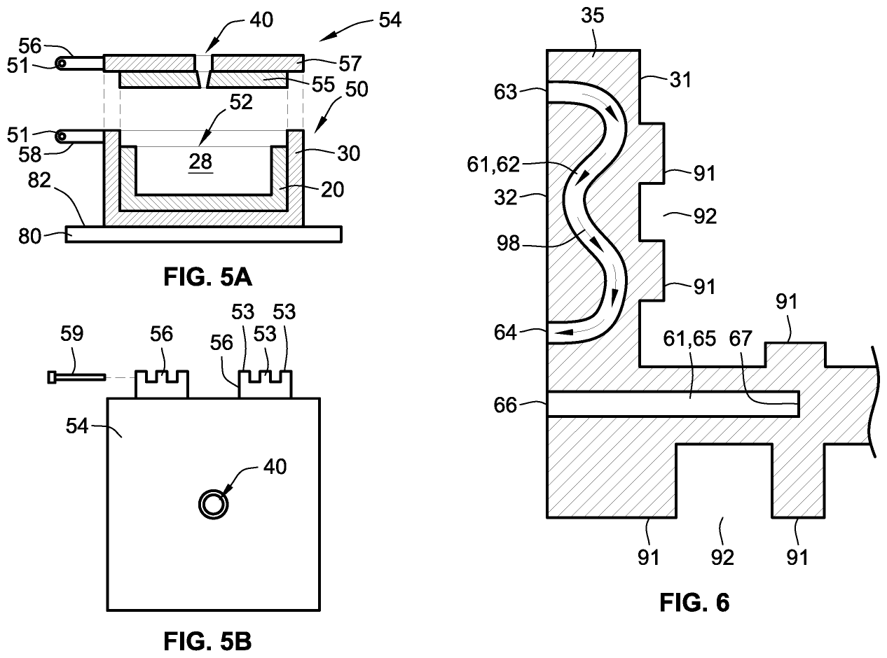

As illustrated by FIGS. 3A and 5, the inner and outer shells 20, 30 may be formed such that nested together they form a container 50 having an open top 52. In this arrangement, the method 100 may further include, at block 150, 3D printing a lid 54 capable of substantially covering the open top 52. The lid 54 may include a first hinge element 56 and one of the inner and outer shells 20, 30 may include a second hinge element 58 operably connectable with the first hinge element 56. Each of the hinge elements 56, 58 may have one or more knuckles 53 with a hole formed through each knuckle 53 to form a tunnel or barrel 51 through which a hinge pin 59 may be formed or inserted. The lid 54 may be produced at the same time or at a different time as when either or both of the inner and outer shells 20, 30 are produced; and, if produced at the same time as one or both of the inner and outer shells 20, 30, it may also be produced integral with such inner and/or outer shells 20, 30. (When the lid 54 is produced, if the inner and outer shells 20, 30 have not yet been nested, then optional block 160 may be executed which includes placing/nesting the inner shell 20 within the outer shell 30.) Additionally, the first hinge element 56 may be produced simultaneously and integral with the lid 54, or it may be produced separately and then assembled onto the lid 54. Likewise, the second hinge element 58 may be produced simultaneously and integral with the inner or outer shell 20, 30, or it may be produced separately and then assembled onto the inner or outer shell 20, 30. Moreover, the lid 54, inner and outer shells 20, 30 and the first and second hinge elements 56, 58 may be 3D printed simultaneously (i.e., as part of a single continuous 3D printing session). A hinge pin 59 may be 3D printed at the same time as one or more of the mold elements (e.g., the first and second hinge elements 56, 58 and the hinge pin 59 may be printed simultaneously with the hinge elements 56, 58 in knuckular engagement with each other and with the hinge pin 59 being 3D printed within the hinge barrel), or a hinge pin 59 may be 3D printed separately and/or at a different time, or an ordinary (e.g., metal and non-3D printed) hinge pin 59 may be inserted post-printing. The lid 54 may be produced from the first or second material, or from a different material. As shown in FIGS. 3A and 5A, the lid 54 may be produced having an inner portion 55 made of the first material and an outer portion 57 made of the second material, thus mimicking the general inner/outer shell structure of the mold 10.

In order to provide additional thermal regulation capability to the mold 10 (i.e., to enhance its thermoregulation capacity), the method 100 may further include (as part of blocks 120 and/or 130) 3D printing at least one thermal regulation element 60 in at least one of the first/outer shell 30 and the second/inner shell 20. As illustrated in FIGS. 1 and 6, a thermal regulation element 60 may include: an interior passage 61 having at least one opening formed in a wall 25, 35 of the inner shell 20 and/or the outer shell 30; a tube 68 formed of a material different from the surrounding material in which the tube is formed; a cartridge heater 69; a resistance heating wire 71; and/or a heat spreader 72. The interior passage 61 may be a through-hole passage 62 or a blind hole passage 65. A through-hole passage 62 may have an entrance opening 63 and an exit opening 64 to provide a flow path 98, with each of the entrance and exit openings 63, 64 being formed in a wall 25, 35 of the inner shell 20 and/or the outer shell 30. A blind hole passage 65 may have a single opening 66 formed in a wall 25, 35 of the inner shell 20 or the outer shell 30, with a bottom or impasse 67 at the end of the passage 65. Since a through-hole passage 62 has an entrance 63 and an exit 64, it may be used to pass fluids therethrough, such as for heating or cooling parts of the mold 10 near the passage 62. Suitable fittings (e.g., for external hoses) may be applied to the openings 63, 64 of the through-hole 62 either after or as part of the 3D printing process. Blind holes 65 may be used to insert, access or control other thermal regulation elements or devices, such as cartridge heaters, thermometers, thermistors, etc.

A thermal regulation element 60 in the form of a tube 68 may be 3D printed within the inner and/or outer shells 20, 30 so that fluids may be passed therethrough for heating or cooling parts of the mold 10 adjacent the tube 68. Printing such a tube 68 may involve printing a void or passage (or in other words, purposely not printing in selected locations so that a void or passage is formed), while printing a lumen within the void or passage, thereby creating a tube 68 embedded or contained within the mold 10 where desired. As with the through-hole passage 62, suitable fittings may be applied to the ends of the tube 68 either after or as part of the 3D printing process. The tube 68 may be printed using a different material than the surrounding material in which it is formed. For example, if the tube 68 is formed in an inner shell 20 made of a thermally conductive material, the tube 68 may be made of a different (e.g., thermally insulative) material, such as the second material or a different material. An optional adhesive or other supporting (e.g., elastomeric) material 97 may be applied adjacent to the tube 68 either as part of the 3D printing process or as a post-printing step. This material 97 may be thermally insulative, thermally conductive or relatively thermally inert.

Thermal regulation elements 60 may also take the form of a cartridge heater 69, a resistance heating wire 71, and/or a heat spreader 72. These elements 60 may be 3D printed using one or more metals, and/or using other non-metallic materials having desired thermal or electrical characteristics. For example, a resistance heating wire 71 or the wire/lead portion of a cartridge heater 69 may be 3D printed using carbon because of its ability to conduct electrical current, or a heat spreader 72 may be printed using carbon because of its ability to conduct heat. As illustrated in FIG. 1A, a resistance heating wire or heating element 71 may include two or more nodes or inlets/outlets 73 where the wire 71 transitions between an interior surface 21 of the inner shell 20 and an interior body of the inner shell 20. (These nodes or inlet/outlet transitions 73 may also appear at the exterior surface 22 of the inner shell 20, as well as at the interior and exterior surfaces 31, 32 of the outer shell 30.) In addition to the one or more thermoregulations elements 60 being provided in the inner and/or outer mold shells 20, 30, such elements 60 may also be provided in the lid 54 as well.

In FIGS. 1A and 1B, a tube 68 is shown on the interior surface 31 of the outer shell 30, a resistance heating wire 71 is shown on an interior surface 21 of the inner shell 20, three cartridge heaters 69 are shown embedded in the floor of the inner shell 20, and two heat spreaders 72 are shown with one being on the inner surface 21 of the floor of the inner shell 20 and the other being embedded within a wall of the inner shell 20. However, each of these thermal regulation elements 60 may be disposed on an interior or exterior surface of either shell 20, 30 or the lid 54, as well as embedded fully or partially within a wall, floor or other portion of either shell 20, 30 or the lid 54. Although the thermal regulation elements 60 are only shown in FIGS. 1 and 6 and are not shown in FIGS. 3 and 5, each of the configurations shown in FIGS. 3 and 5 could include one or more thermal regulation elements 60. The thermal regulation elements 60 have been excluded from FIGS. 3 and 5 merely for convenience and to highlight other features of the thermoregulated mold 10, such as the various configurations of inner and outer shells 20, 30 and the lid 54.

It should be noted that while the inner surface 21 and inner cavity 28 of the inner shell 20 has been illustrated in the drawings such that a generally “rectangular box” would be produced by the mold 10, this is merely for illustration purposes. For a part having an outer surface of some other shape, the inner surface 21 of the inner shell 20 would be shaped and dimensioned to generally correspond with such shape. Also, while the drawings also show that the inner and outer shells 20, 30 each have a generally uniform thickness, the thickness of each shell 20, 30 may vary as between the two shells 20, 30 and may also vary as among different locations within each respective shell 20, 30.

While FIGS. 3A through 3C illustrate thermoregulated molds having an open top 52 (onto which an optional lid 54 may be placed), FIGS. 3D and 3E illustrate two different configurations of “closed” molds 10. FIG. 3D shows a mold 10 having a top portion 12 and a bottom portion 14, and FIG. 3E shows a mold 10 having a left portion 16 and a right portion 18. In each configuration, the two portions (12 and 14, or 16 and 18) may be 3D printed simultaneously or at different times. Although each configuration shows two portions, it is possible that three or more portions may be produced to form a singular mold 10. Also, while the configurations are shown as having straight/planar parting lines between the two portions, the parting or mating lines may have other geometries (including complex geometries), and the orientations of the mating portions may be other than the top/bottom and left/right configurations shown in the drawings.

As shown in FIGS. 1A and 1B, the outer shell 30 may include ribs, feet and other promontories 91 extending outward (toward the outside of the mold 10) from the exterior surface 32 or inward (toward the inside of the mold 10) from the interior surface 31, as well as gaps or troughs 92 extending inward from the exterior surface 32 or outward from the interior surface 31. Although not explicitly shown in the drawings, a similar set of promontories 91 or gaps/troughs 92 may be formed in the inner shell 20 as well. One or both of the shells 20, 30 may also include one or more alignment pins or alignment holes 93 which may be used to align the shells 20, 30 with respect to each other, and/or to align one or both shells 20, 30 with external structures such as platens or mold plates on injection molding machines, thermoforming machines, vacuum/pressure forming machines and the like. The exterior surface 32 of the outer shell 30 may include one or more pockets 94 for grasping and manipulating the mold 10 or shell 30. Such pockets 94 may also be fitted with appropriate through-holes to allow the shell 30 to be bolted or secured to a platen, mold plate or the like, such as by using threaded fasteners 95 and washers 96. The exterior 32 of the outer shell 30 may also have female threaded inserts or male threaded studs embedded in the floor or walls 35 so that external jigs, tools, fixtures, etc. may be fastened thereto. Likewise, the exterior 22 of the inner shell 20 may have female threaded inserts or male threaded studs embedded in the floors and/or walls 25 so that the outer shall 30 may be fastened to the inner shell 20. The outer shell 30 may also have through-holes formed through its floor and/or walls 35 so that an external jig, tool, fixture or other hardware item may be fastened to the inner shell 20 through such through-hole, thereby sandwiching the outer shell 30 between the inner shell 20 and the external hardware item. Slip planes, slots and other features designed to allow for thermal expansion between the inner and outer shells 20, 30 may also be incorporated. Additionally, metal tubes, rods and the like may be 3D printed (or later inserted) into the outer shell 30 to provide additional strength and durability to the overall mold 10, such as for supporting higher pressure molding processes and/or transport of the mold 10.

One advantage of using the two-part inner/outer shell structure of the thermoregulated mold 10 is that allows the designer to separate the finer cosmetic aspects of part production from the rugged production and through-put aspects of part production. Thus, the inner shell 20 can be designed with the part's surface finish, geometric intricacies, and other delicate cosmetic aspects attended to as part of the inner shell 20, while the outer shell 30 can be designed for attending to the robustness and handling of the overall mold 10. Additionally, the two-part inner/outer shell structure also allows the designer to separate many of the thermal management aspects of part production between the inner and outer shells 20, 30, and even enables thermal management capabilities that would otherwise be more difficult, more expensive or even impossible with other molds.

The above description is intended to be illustrative, and not restrictive. While various specific embodiments have been presented, those skilled in the art will recognize that the disclosure can be practiced with various modifications within the spirit and scope of the claims. For example, the above-described embodiments (and/or aspects thereof) may be used in combination with each other. Additionally, in the following claims, use of the terms “first”, “second”, “top”, “bottom”, etc. are used merely as labels, and are not intended to impose numerical or positional requirements on their objects. Further, the limitations of the following claims are not written in means-plus-function or step-plus-function format and are not intended to be interpreted as such, unless and until such claim limitations expressly use the phrase “means for” or “step for” followed by a statement of function void of further structure. As used herein, an element or step recited in the singular and preceded by the word “a” or “an” should be understood as not excluding plural of such elements or steps, unless such exclusion is explicitly stated. Furthermore, references to a particular embodiment or example are not intended to be interpreted as excluding the existence of additional embodiments or examples that also incorporate the recited features. Moreover, unless explicitly stated to the contrary, embodiments “comprising” or “having” an element or a plurality of elements having a particular property may include additional such elements not having that property. And when broadly descriptive adverbs such as “substantially” and “generally” are used herein to modify an adjective, such as in the phrase “substantially covering” or “generally conforming”, these adverbs mean “for the most part”, “to a significant extent” and/or “to a large degree”, and do not necessarily mean “perfectly”, “completely”, “strictly” or “entirely”. Additionally, the word “proximate” may be used herein to describe the location of an object or portion thereof with respect to another object or portion thereof, and/or to describe the positional relationship of two objects or their respective portions thereof with respect to each other, and may mean “near”, “adjacent”, “close to”, “close by”, “at” or the like.

This written description uses examples, including the best mode, to enable those skilled in the art to make and use devices, systems and compositions of matter, and to perform methods, according to this disclosure. It is the following claims, including equivalents, which define the scope of the present disclosure.

What is claimed is:

1. A mold for producing a part, comprising:
a 3D printed outer shell made of a first material, the outer shell having a first interior surface and a first exterior surface; and
a 3D printed inner shell made of a second material different from the first material, the inner shell having a second interior surface and a second exterior surface, wherein the inner shell is disposed within the outer shell with the second exterior surface in contact with the first interior surface.

2. A mold according to claim 1, wherein the first material is thermally insulative and the second material is thermally conductive.

3. A mold according to claim 1, wherein the first interior surface generally conforms to the second exterior surface.

4. A mold according to claim 1, wherein the inner and outer shells form a substantially closed container.

5. A mold according to claim 1, wherein at least one portion of the inner shell is electrically conductive.

6. A mold according to claim 1, wherein a first opening is formed in a first wall of the inner shell at a first location, and a second opening is formed in a second wall of the outer shell at a second location corresponding to the first location, wherein the first and second openings cooperate to form an injection port through the first and second walls.

7. A mold according to claim 1, wherein the inner and outer shells form a container having an open top, further comprising:
a 3D printed lid capable of substantially covering the open top.

8. A mold according to claim 7, wherein the lid includes a first hinge element and one of the inner and outer shells includes a second hinge element operably connectable with the first hinge element.

9. A mold according to claim 1, further comprising:
a 3D printed thermal regulation element formed in at least one of the inner shell and the outer shell, wherein the thermal regulation element includes at least one of:
an interior passage having at least one opening formed in a wall of the at least one of the inner shell and the outer shell;
a tube formed of a material different from a surrounding material in which the tube is formed;
a cartridge heater;
a resistance heating wire; and
a heat spreader.

10. A mold according to claim 9, wherein the thermal regulation element is 3D printed simultaneously with the at least one of the first mold shell and the second mold shell in which the at least one thermal regulation element is formed.

11. A thermoregulated mold for producing a part, comprising:
a 3D printed first mold shell made of a thermally insulative material, the first mold shell having a first interior surface and a first exterior surface;
a 3D printed second mold shell made of a thermally conductive material, the second mold shell having a second interior surface and a second exterior surface, wherein the second exterior surface generally conforms to the first interior surface; and
at least one 3D printed thermal regulation element formed in at least one of the first mold shell and the second mold shell, wherein the at least one thermal regulation element includes at least one of:
a through-hole passage having an entrance opening and an exit opening, each of the entrance and exit openings being formed in a wall of the at least one of the first mold shell and the second mold shell;
a blind hole passage having a single opening formed in a wall of the at least one of the first mold shell and the second mold shell;
a tube formed of a material different from a surrounding material in which the tube is formed;
a cartridge heater;
a resistance heating wire; and
a heat spreader.

12. A thermoregulated mold according to claim 11, wherein the at least one thermal regulation element is 3D printed simultaneously with the at least one of the first mold shell and the second mold shell in which the at least one thermal regulation element is formed.

13. A thermoregulated mold according to claim 11, wherein the first mold shell, the second mold shell and the at least one thermal regulation element are 3D printed simultaneously.

14. A thermoregulated mold according to claim 11, wherein a first opening is formed in a first wall of the first mold shell at a first location and a second opening is formed in a second wall of the second mold shell at a second location corresponding to the first location, such that an injection port is formed by the first and second openings if the first and second mold shells are nested together with the first and second openings in registration with each other.

15. A thermoregulated mold according to claim 11, wherein the first and second mold shells form a container having an open top, further comprising:
a 3D printed lid capable of substantially covering the open top, wherein the lid includes a first hinge element and one of the first and second mold shells includes a second hinge element operably connectable with the first hinge element.

16. A method of fabricating a thermoregulated mold for producing a part, comprising:
3D printing an outer shell using a thermally insulative material, the outer shell having a first interior surface and a first exterior surface;
3D printing an inner shell using a thermally conductive material, the inner shell having a second interior surface and a second exterior surface, wherein the second exterior surface generally conforms to the first interior surface; and
3D printing at least one thermal regulation element in at least one of the outer shell and the inner shell, wherein the at least one thermal regulation element includes at least one of:
a through-hole passage having an entrance opening and an exit opening, each of the entrance and exit openings being formed in a wall of the at least one of the outer shell and the inner shell;
a blind hole passage having a single opening formed in a wall of the at least one of the outer shell and the inner shell;
a tube formed of a material different from a surrounding material in which the tube is formed;
a cartridge heater;
a resistance heating wire; and
a heat spreader.

17. A method according to claim 16, wherein the outer and inner shells are 3D printed simultaneously with the inner shell nested within the outer shell with the first interior surface in contact with the second exterior surface.

18. A method according to claim 16, wherein the outer and inner shells are 3D printed separately, further comprising:
fitting the inner shell within the outer shell with the first interior surface in contact with the second exterior surface.

19. A method according to claim 16, wherein a first opening is formed in a first wall of the outer shell at a first location and a second opening is formed in a second wall of the inner shell at a second location corresponding to the first location, such that the first and second openings cooperate to form an injection port if the outer and inner shells are nested together with the first and second openings in registration with each other.

20. A method according to claim 16, wherein the outer and inner shells are formed such that nested together they form a container having an open top, further comprising:
3D printing a lid capable of substantially covering the open top, wherein the lid includes a first hinge element and one of the outer and inner shells includes a second hinge element operably connectable with the first hinge element.
